(19) United States
(12) Patent Application Publication
(10) Pub. No.: US 2002/0190962 A1
(43) Pub. Date: Dec. 19, 2002

(54) Electronic apparatus having a power saving mode and method for controlling the same

(75) Inventor: Hirotsuna Miura, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/146,962

(22) Filed: May 17, 2002

(30) Foreign Application Priority Data
May 17, 2001 (JP) 2001-147335

(51) Int. Cl. G09G 5/00

(52) U.S. Cl. 345/173

(57) ABSTRACT

The invention provides an electronic apparatus and power control methods therefore, which effectively start a power saving mode. When the power supply is turned on, a suspend timer and a sampling timer are operated. Upon key touches, judgments are made as to whether key inputs given are valid or invalid. When, for example, a sampling period of 30 seconds has passed, the numbers of valid and invalid count values calculated in a touch interrupt routine can be compared. Samplings can be conducted at intervals of 30 seconds, and if a time interval, such as 5 minutes, passes without any valid inputs being made, a suspend process can be conducted, and a power saving mode can be started.

### BACKGROUND OF THE INVENTION

1. Field of Invention

The present invention relates to electronic apparatuses, such as mobile information terminals, and methods for controlling the power of the same. More particularly, the present invention relates to electronic apparatuses that can effectively shift into a power saving mode.

2. Description of Related Art

Advances in semiconductor technologies in recent years have made it possible to develop small-sized mobile information terminal apparatuses in which functions of information processing apparatuses, such as personal computers, are condensed and implemented. These apparatuses are so-called PDAs (personal digital assistants). For example, among PDAs, mobile telephone apparatuses, such as so-called PDCs (digital mobile telephones) and PHSs (personal handy-phone systems), are rapidly becoming popular.

Electronic apparatuses for these mobile information terminals are driven by batteries and other power sources. Also, the electronic apparatuses are equipped with touch panels or the like that allow inputs through their liquid crystal display screens or by depressing the screens, and more and more multiple functions are implemented in the apparatuses.

Currently, these electronic apparatuses can be equipped with a power saving (suspend) mode that suppresses power consumption to enable the use of the apparatuses for an extended period of time. This mode employs a method that performs certain measures, such as a step in which the liquid crystal display stops displaying after a predetermined period of time even when the power switch is on but there are no inputs.

FIG. 12 is a flow chart of a conventional power saving method of electronic apparatuses. Referring to FIG. 12, initially, when a power supply for the electronic apparatus is turned on (step 101), a suspend timer that measures the time until a suspend operation takes place is started (step 102). The suspend timer measures the time until the apparatus is put in a power saving mode. For example, it can set at 5 minutes. Then, the software running on the apparatus can be placed in a standby state to wait for inputs from a touch panel or the like.

When there is an input from the touch panel (step 103), the suspend timer is reset (step 104), and the suspend timer is started anew (step 102) to measure the time until the apparatus is put in the power saving mode. Also, when there are no inputs from the touch panel or the like, and a set time has passed (Time Over) (step 106), the power saving mode is started (step 107).

### SUMMARY OF THE INVENTION

In the conventional power control method described above, when inputs are given through the touch panel or the like, the power saving mode does not start. However, for example, when the user forgets to turn off the power on the mobile electronic apparatus and places the apparatus in their clothes or a bag, the clothes may often contact the touch panel or the like, to cause frequent inputs. In this case, the power saving mode may not be started, which would waste the power.

Also, a child may wantonly operate the touch panel of the electronic apparatus. In such a case, problems may occur. For example, not only does the power saving mode not start, but also stored data may be carelessly transmitted out or erased.

The present invention is made in view of the problems described above, and an object is to provide electronic apparatuses and power control methods therefore that effectively start a power saving mode.

To solve the problems described above, an electronic apparatus in accordance with the present invention can include a display device, such as a liquid crystal panel, an input device such as a touch panel provided on the display device, a timer that calculates specified suspend time and sampling time, and a counter that counts a specified number of key inputs. The apparatus can further include a power control device that controls a power supply, a judging device that judges at each of the sampling time if a key input inputted through the input device is valid or invalid, and a control device that controls the display device, the input device, the timer, the counter, the power control device and the judging device. Based on judgment results by the judging device, the control device can count valid inputs with the counter when the key inputs inputted through the input device are judged to be valid, counts invalid inputs with the counter when the key inputs inputted through the input device are judged to be invalid, and compares the number of the valid key inputs with the number of the invalid key inputs to make a determination. The control device resets and restarts the timer that measures the specified suspend time when a ratio of the number of the valid inputs to the number of the invalid inputs is less than a specified threshold value, and controls the power control device to start a power saving mode when a measured result of the timer reaches the suspend time.

By this, while valid inputs are being made, the power saving mode is not started. However, when invalid inputs are being made, and a specified time has passed, the power saving mode can be started. Accordingly, the power can be more effectively controlled.

In the electronic apparatus, a valid input region and an invalid input region are provided in the display device, and the control device judges that a key input in the valid input region is valid and a key input in the invalid input region is invalid.

In the electronic apparatus, when a validity rate (the number of valid inputs/the number of all inputs) obtained from the counted value of the counter exceeds a specified threshold value, the timer that measures the specified suspend time may be reset and restarted. In this manner, when the set validity rate is exceeded, the time for starting the power saving mode (suspend timer) can be restarted, and the apparatus can be used without being placed in the power saving mode while valid inputs are made.

In the electronic apparatus, when a measured result of the timer reaches the suspend time while a validity rate (the number of valid inputs/the number of all inputs) obtained from the counted value of the counter does not exceed a specified threshold value, the power control device may also be controlled to start a power saving mode.

As a result, even when the user forgets to turn off the power on the mobile electronic apparatus and places the same in their clothes or a bag, and the clothes often contacts the touch panel or the like to cause frequent inputs, the power saving mode can be started after a specified time has passed if the validity rate of key inputs is low.

In the electronic apparatus, when an invalidity rate (the number of invalid inputs/the number of all inputs) obtained from the counted value of the counter exceeds a specified threshold value, the power control device may also be controlled to start a power saving mode even when a measured result of the timer has not reached the suspend time.

As a result, when someone else inputs incorrect passwords several times, which makes the invalidity rate greater, the power saving mode can be started even before the suspend time is reached. The time until the password is released can be extended.

In the electronic apparatus, when the number of invalid inputs exceeds a specified threshold value, the power control device may also be controlled to start a power saving mode even when a measured result of the timer has not reached the suspend time.

As a result, if a child wantonly makes invalid key inputs several times but the invalidity rate is relatively low, the power saving mode can be started even before the suspend time is reached.

A power control method in accordance with the present invention can include displaying information on a display device such as a liquid crystal panel, receiving key inputs from an input device such as a touch panel provided on the display device, and calculating specified suspend time and sampling time by a timer, and counting a specified number of key inputs by a counter. The method can further include judging at each of the sampling time if a key input inputted through the input device is valid or invalid, and controlling a power supply. Based on results of the judging as to validity/invalidity, valid inputs are counted with the counter when the key inputs inputted through the input device are judged to be valid, invalid inputs are counted with the counter when the key inputs inputted through the input device are judged to be not valid, and the number of the valid key inputs is compared with the number of the invalid key inputs to make a determination, wherein the timer that measures the specified suspend time is reset and restarted when a ratio of the number of the valid inputs to the number of the invalid inputs is less than a specified threshold value, and the power supply is controlled to start a power saving mode when a measured result of the timer reaches the suspend time.

In the power control method, a valid input region and an invalid input region are provided in the display device, and a key input in the valid input region may be judged to be valid and a key input in the invalid input region may be judged to be invalid.

In the power control method, when a validity rate (the number of valid inputs/the number of all inputs) obtained from the counted value of the counter exceeds a specified threshold value, the timer that measures the specified suspend time may be reset and restarted.

In the power control method, when a measured result of the timer reaches the suspend time while a validity rate (the number of valid inputs/the number of all inputs) obtained from the counted value of the counter does not exceed a specified threshold value, the power control device may be controlled to start a power saving mode.

In the power control method, when an invalidity rate (the number of invalid inputs/the number of all inputs) obtained from the counted value of the counter exceeds a specified threshold value, the power control device may be controlled to start a power saving mode even when a measured result of the timer has not reached the suspend time.

In the power control method, when the number of invalid inputs exceeds a specified threshold value, the power control device may be controlled to start a power saving mode even when a measured result of the timer has not reached the suspend time.

### BRIEF DESCRIPTION OF THE DRAWINGS

The invention is described with reference to the accompanying drawings wherein like numerals reference like elements, and wherein:

FIG. 1 shows a perspective, partially exploded view of an outline of an electronic apparatus in accordance with the embodiment of the present invention;

FIG. 2 shows a cross-sectional side view of a structure of the liquid crystal panel and the touch panel;

FIG. 3 shows a drawing to describe an outline of an apparatus for measuring depressed positions of the touch panel;

FIG. 4 shows a drawing to describe a display region of the liquid crystal panel 3;

FIG. 5 shows a block diagram of a structure of the system of the mobile information terminal 1;

FIG. 6 shows a program routine that realizes a power control method for the mobile information terminal 1;

FIG. 7 shows a drawing to describe a power control method in accordance with a first embodiment of the present invention;

FIG. 8 shows a drawing to describe a power control method in accordance with a second embodiment of the present invention;

FIG. 9 shows a drawing to describe a power control method in accordance with a third embodiment of the present invention;

FIG. 10 shows a drawing to describe a power control method in accordance with a fourth embodiment of the present invention;

FIG. 11 shows a drawing to describe a power control method in accordance with a fifth embodiment of the present invention; and

FIG. 12 shows a flow chart of a conventional power saving method of electronic apparatuses.

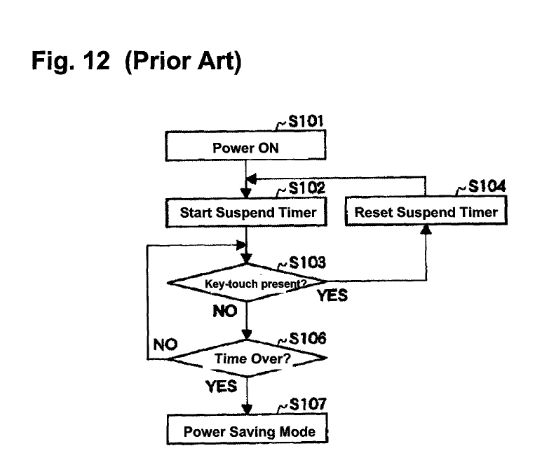

### DETAILED DESCRIPTION OF PREFERRED EMBODIMENTS

Descriptions will be made with reference to the accompanying drawings. First, an outline of an electronic apparatus in accordance with an embodiment of the present invention will be described.

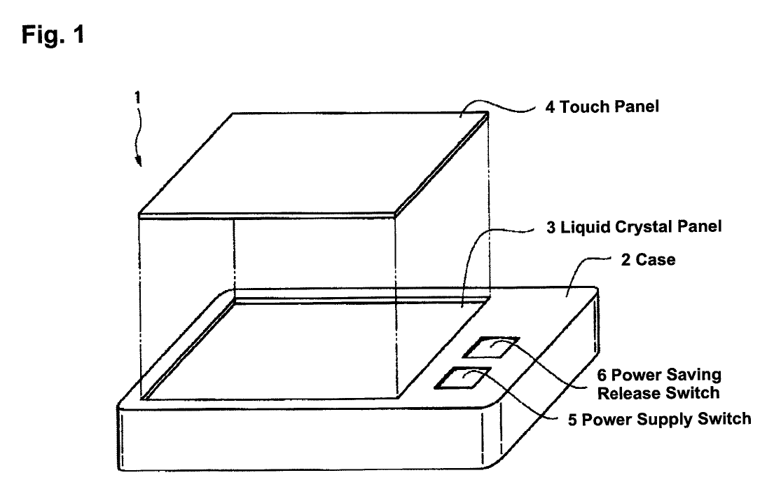

FIG. 1 shows a perspective, partially exploded view of an outline of an electronic apparatus in accordance with the embodiment of the present invention.

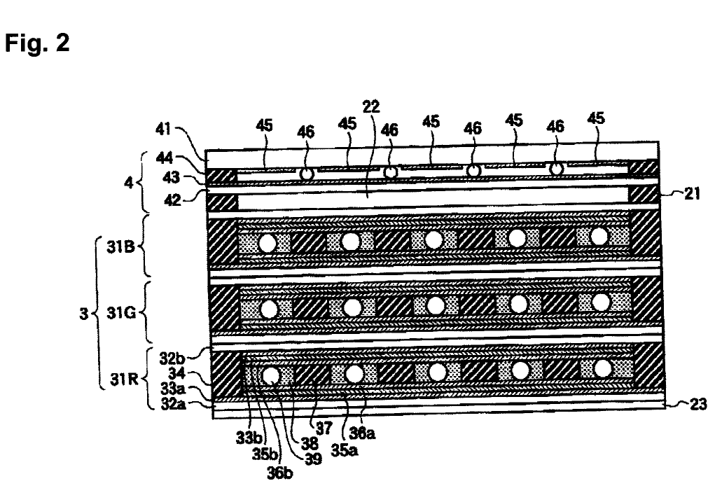

FIG. 1 shows a small size mobile information terminal 1, as an example of the electronic apparatus in accordance with the embodiment of the present invention. The mobile information terminal 1 can be provided with a case 2 made of formed plastic or the like. A liquid crystal panel 3 that displays information can be embedded in a top surface of the case 1 in its central area in the figure. A touch panel 4 that allows inputs by pressing its surface is shown in an exploded view above the liquid crystal panel 3 in the figure. Structures of the liquid crystal panel 3 and the touch panel 4 will be described in greater detail below with reference to FIG. 2. Also, a power supply button 5 that turns on and off the power supply of the mobile information terminal 1, and a power saving mode release switch 6 to release a power saving state are provided on the upper surface of the case 2 on the right-hand side in the figure. Although not shown, batteries, a power supply for the mobile information terminal 1, and an integrated circuit that realizes predetermined functions of the mobile information terminal 1 are provided inside the case 2. Also, in some cases, a touch pen or the like for pressing the touch panel 4 may be provided on the case.

FIG. 2 is a cross-sectional side view of a structure of the liquid crystal panel and the touch panel. FIG. 2 shows the liquid crystal panel 3 and the touch panel 4 disposed on the liquid crystal panel 3. The liquid crystal panel 3 and the touch panel 4 are fixed to each other with adhesive 21 at end faces thereof, and are provided with a gap 22 having a predetermined distance at their central area. Also, a light absorbing layer 23 is disposed below the liquid crystal panel 3.

The liquid crystal panel 3 can include a red color display layer 31R for red color display, a green color display layer 31G for green color display, and a blue color display layer 31B for blue color display, which are stacked in layers in this order from the bottom. A transparent substrate 32a in a flat plate shape having a predetermined thickness is provided at the bottom of each of the display layers 31R, 31G and 31B. On the other hand, a transparent substrate 32b in a flat plate shape having a predetermined thickness is provided at the top of each of the display layers 31R, 31G and 31B, in a manner confronting to the substrate 32a. A conductive film 33a in a thin flat plate shape is provided on the top surface of the substrate 32a. Edge sections of the conductive film 33a and the substrate 32b are affixed through a seal member 34. A transparent conductive film 33b in a thin flat plate shape is provided on the bottom surface of the substrate 32b, like the substrate 32a. Depending on the requirements, insulation films 35a and 35b and orientation control films 36a and 36b are provided on the top surface of the conductive film 33a and the bottom surface of the conductive film 33b, respectively. A plurality of resin column structures 37 are disposed at regular intervals between the orientation control films 36a and 36b. Also, a plurality of spherical spacers 39 are disposed between the orientation control films 36a and 36b. Furthermore, liquid crystal 38 is filled in a gap between the orientation control films 36a and 36b.

Transparent substrates 41 each in a flat plate shape having a predetermined thickness are disposed opposing each other on the top and bottom surfaces of the touch panel 4, respectively. A transparent conductive film 43 in a thin flat plate shape having a uniform resistance distribution is provided on the top surface of the substrate 42. Circumferential portions of the conductive film 41 and the substrate 41 are affixed together with adhesive 44. A transparent conductive film 45 in a thin flat plate shape having a uniform resistance distribution is provided on the bottom surface of the substrate 41, like the substrate 42. The conductive film 45 is provided with a plurality of through holes, and spherical spacers 46 are disposed in the respective through holes.

Next, a description is made as to a method for measuring pressing positions on the touch panel.

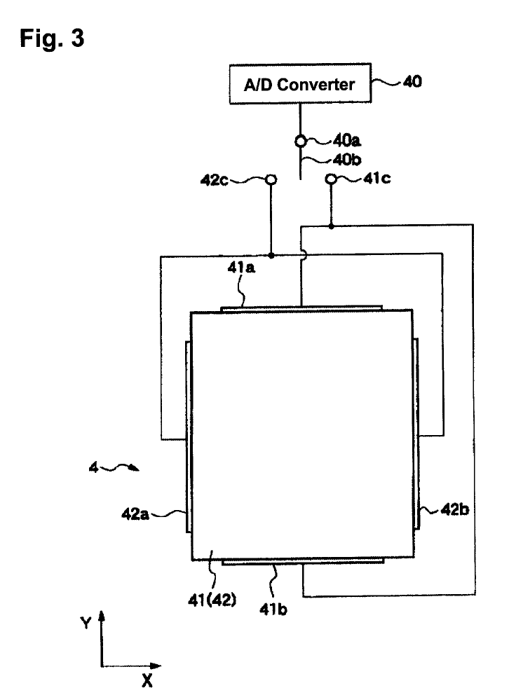

FIG. 3 is a drawing to describe an outline of an apparatus for measuring pressed positions of the touch panel. In FIG. 3, a right-to-left direction in the figure is defined to be an X-direction, and an up-to-bottom direction is defined to be a Y-direction.

FIG. 3 is a plan view of the substrate 41 shown in FIG. 2. Electrodes 41a and 41b that extend in the lateral direction in the figure are provided on upper and lower ends of the substrate 41 in the figure. The electrodes 41a and 41b are connected to the conductive film 45 (see FIG. 2) provided on the bottom surface of the substrate 41. Also, the substrate 42 (see FIG. 2) is disposed below the substrate 41 shown in FIG. 3. Also, electrodes 42a and 42b that extend in the longitudinal direction in the figure are provided on left and right ends of the substrate 42 in the figure. The electrodes 42a and 42b are connected to the conductive film 43 (see FIG. 2) provided on the upper surface of the substrate 42. Wirings that extend from the electrodes 41a and 41b are connected to a terminal 41c. Also, wirings that extend from the electrodes 42a and 42b are connected to a terminal 42c. A constant voltage from a power supply (not shown) is applied to each of the electrodes.

FIG. 3 also shows an A/D converter 40 that converts an analog signal provided by the touch panel 4 into a digital signal. A wiring of the A/D converter 40 is connected to the terminal 40a. The terminal 40a is provided with a switching switch 40b that switches between the terminal 41c and the terminal 42c.

When the touch panel 4 is depressed at a certain area, the conductive films 43 and 45 at that area contact to each other and cause a voltage gradient. At this moment, for example, the switching switch 40b is connected to the terminal 41c, and a voltage value between the electrodes 41a and 41b is read with the A/D converter 40, whereby a position of the depressed area in the Y-direction can be detected. On the other hand, the switching switch 40b is connected to the terminal 42c, and a voltage value between the electrodes 42a and 42b is read with the A/D converter 40, whereby a position of the depressed area in the X-direction can be detected. In this manner, by alternately conducting the switching operations of the switching switch 40b, X-Y coordinates positions of depressed areas on the touch panel 4 can be detected.

Next, a description will be made as to a display region of the liquid crystal panel 3.

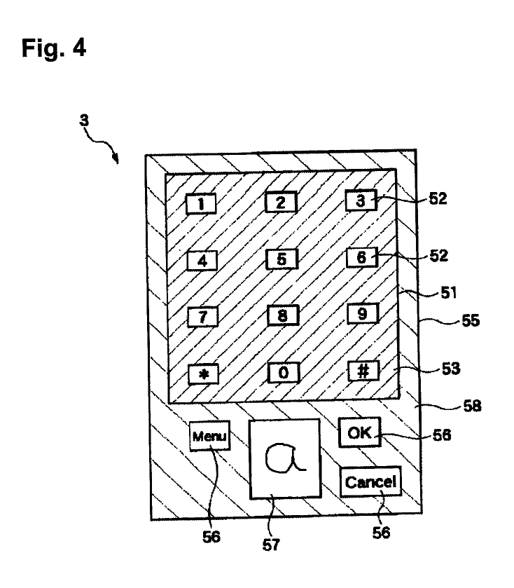

FIG. 4 shows one example of a display screen of the liquid crystal panel 3 (see FIG. 1). The display screen region is generally divided into two regions. One of them is a first display region 51 within a rectangular frame that is disposed in the central area of the liquid crystal panel 3. The other is a second display region 55 within a rectangular frame outside the first display region 51. Regions within the first display region 51 and the second display region 55 contain valid input regions of the touch panel 4.

The first display region 51 displays therein numeric buttons “0 and 1-9”, and button images 52 such as “*” and “#”, as an example. Here, portions that display the button images 52 within the first display region 51 are defined as valid input regions. When these portions are depressed, inputs are judged to be “valid inputs.” Portions that do not display the button images 52 within the first display region 51 are defined as invalid input regions 53. When these portions are depressed, inputs are judged to be “invalid inputs.” The first display region 51 is displayed by an application software of the mobile information terminal (see FIG. 1).

The second display region 55 below the first display region 51 displays therein button images 56, such as “MENU”, “OK” and “Cancel”, and a manual input character input region 57 that allows manual inputs of characters, as an example. Here, portions of the button images 56 and the manual input character input region 57 within the second display region 55 are defined as valid input regions. When these portions are depressed, inputs are judged to be “valid inputs.” Portions other than the button images 56 and the manual input character input region 57 within the second display region 55 are defined as invalid input regions 58. When these areas are depressed, inputs are judged to be “valid inputs.” The buttons displayed in the second display region 55 are fixed by a system, and are monitored by the operating system of the mobile information terminal 1 (see FIG. 1).

Next, a system of the mobile information terminal 1 will be described.

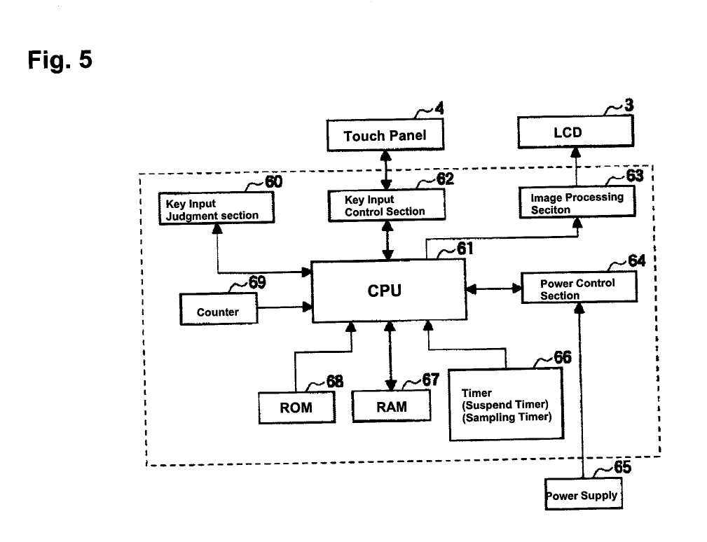

FIG. 5 is a block diagram of a structure of the system of the mobile information terminal 1. FIG. 5 shows at its central area a CPU 61 that controls the system of the mobile information terminal 1. The CPU 61 is connected to the touch panel 4 (see FIG. 1, etc.) through a key input control section 62 that is equipped with the A/D converter (see FIG. 3) and the like. The CPU 61 is also connected to the liquid crystal panel 3 (see FIG. 1, etc.) through an image processing section 63 that controls application voltages of the conductive films of the liquid crystal panel (see FIG. 2). Further, the CPU 61 is equipped with a power supply 65, such as a battery device, that is connected through a power control section 64 that performs a transition process to shift the system into a power saving mode, a timer that measures a transition time toward a power saving (suspense) mode and an input sampling time (hereafter called a “suspend timer”, and a “sampling timer”, respectively), a counter 69 that counts the numbers of valid inputs and invalid inputs, a ROM 68 that stores an application software and the like, a RAM 67 that stores commands and set values inputted through the touch panel 4, and a key input judging section 60 that judges if key inputs are valid or invalid.

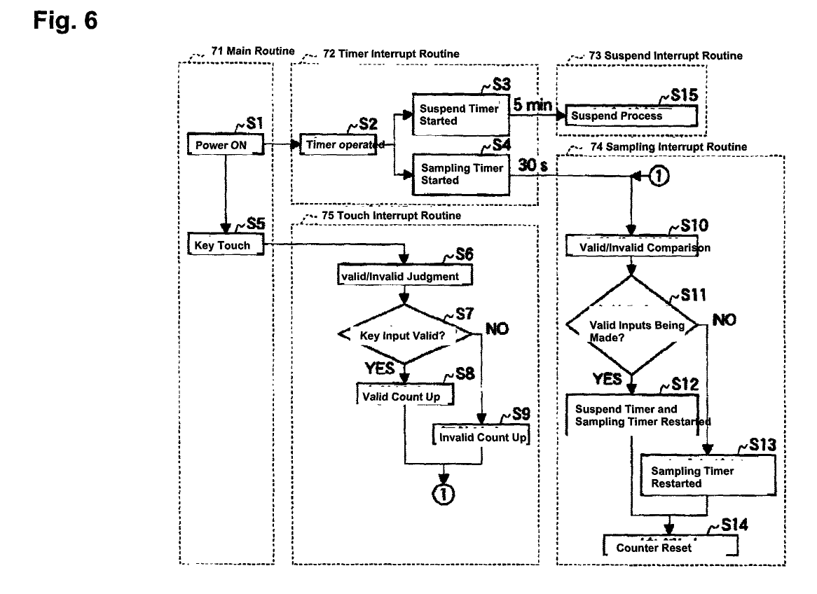

Next, a power control method in accordance with an embodiment of the present invention will be described. FIG. 6 shows a program routine that realizes the power control method for the mobile information terminal 1.

FIG. 6 shows a main routine 71 that performs a basic process of the mobile information terminal 1, a timer interrupt routine 72 that operates the timer that measures a transition time toward the power saving (suspend) mode and an input sampling time, a suspend interrupt routine 73 that performs a power saving (suspend) process that stops display of the liquid crystal screen, a sampling interrupt routine that compares frequencies of valid inputs and invalid inputs at each sampling time, and a touch interrupt process routine 75 that counts the numbers of valid inputs and invalid inputs when keys on the touch panel 4 are touched.

When the power supply is turned on in the main routine 75 (step 1), an interrupt process is conducted in the timer interrupt routine 72.

In the timer interrupt routine 72, the timer (see FIG. 5) is operated (step 2). Here, as described above, the suspend timer that measures the transition time toward the power saving (suspend) mode is operated (step 3), and the sampling timer that measures the input sampling time is operated (step 4). Here, the transition time toward the power saving (suspend) mode is set at 5 minutes, and the input sampling time is set at 30 seconds, as an example. When the timer is operated, the process in the main routine 75 is restarted.

In the main routine 75, when a key on the touch panel 4 is touched (step 5), an interrupt process is conducted in the touch interrupt process routine 75.

In the touch interrupt process routine 75, a judgment is initially made as to whether the key input given is valid or invalid (step 6). As described above with reference to FIG. 3, X-Y coordinates of a depressed portion on the touch panel 4 can be measured. Therefore, the judgment can be made by checking if the coordinates are within the valid input regions shown in FIG. 4. When the key input is valid (step 7), the counter (see FIG. 5) increases the valid count by one (step 8). When the key input is invalid (step 7), the counter increases the invalid count by one (step 9). The count value is returned to the main routine 75, and the process by the main routine 75 is restarted.

Here, when the sampling time of 30 seconds passes, an interrupt process is conducted in the sampling interrupt routine 74.

In the sampling interrupt routine 74, the numbers of value count values and invalid count values measured in the touch interrupt process routine 75 are compared (step 10).

Here, a valid input rate (the number of valid key inputs/the number of all inputs), the frequency of invalid inputs, and the like may be used as comparison references, which can be set in a variety of ways. These comparison references will be described in greater detail below with reference to exemplary embodiments.

When it is judged that the input is valid (step 11), the suspend timer and the sampling timer are restarted (step 12), and the counter is reset (step 14). By resetting the suspend timer, the apparatus can be used without shifting into the power saving mode as long as valid inputs are made.

When it is judged that the input is invalid (step 11), the sampling timer is restarted (step 13), and the counter is reset (step 14). The sampling timer is reset, and after 30 seconds, a key input validity judgment is conducted again.

As described above, samplings are conducted at intervals 30 seconds, and if 5 minutes passes without valid inputs being made, the suspend process is conducted, and the power saving mode is started (step 15).

Next, the power control method in accordance with the present invention will be described with reference to exemplary embodiments.

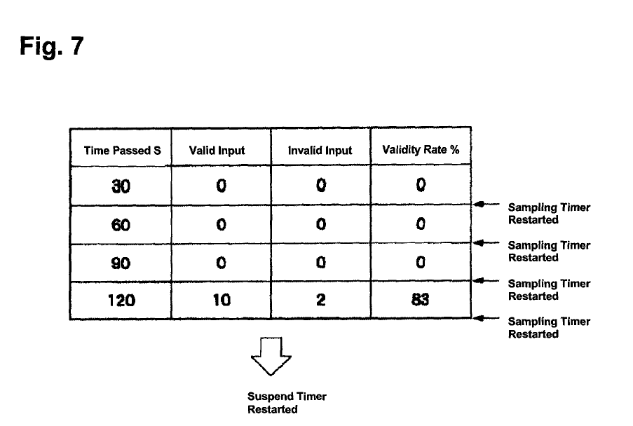

FIG. 7 shows a drawing to describe the power control method in accordance with a first embodiment of the present invention. In this embodiment, for example, the following settings are made.

Suspend time: 5 minutes

Sampling time: 30 seconds

Valid/Invalid comparison reference: The suspend timer is restarted when a validity rate (the number of valid key inputs/the number of all inputs) exceeds 80%.

FIG. 7 shows elapsed times at 30 seconds intervals, and the number of valid inputs, the number of invalid inputs, and the validity rate (the number of valid key inputs/the number of all inputs) in each of these passages of time.

In this example, since there is no input for 30 seconds after the power is turned on, the number of valid inputs is 0, the number of invalid inputs is 0, and the validity rate is 0%. In this case, since the validity rate does not exceed 80%, the suspend timer continues its measuring operation, and the sampling timer is restarted.

Since there is no input during the sampling period in the next 30 seconds (until 60 seconds passes), the number of valid inputs is 0, the number of invalid inputs is 0, and the validity rate is 0%. In this case also, since the validity rate does not exceed 80%, the suspend timer continues its measuring operation, and the sampling timer is restarted.

Also, there is no input during the sampling period in the next 30 seconds (until 90 seconds passes), the number of valid inputs is 0, the number of invalid inputs is 0, and the validity rate is 0%. In this case also, the suspend timer continues its measuring operation, and the sampling timer is restarted.

In the sampling period in the following 30 seconds (until 120 seconds passes), inputs are made, in which the number of valid inputs is 10, the number of invalid inputs is 2, and the validity rate is 83%. In this case, since the validity rate exceeds 80%, the suspend timer continues and the sampling timer is restarted

In this manner, when the set validity rate is exceeded, the time to start the power saving mode (the suspend timer) can be restarted, such that the apparatus can be used without being put in the power saving mode while valid inputs are made.

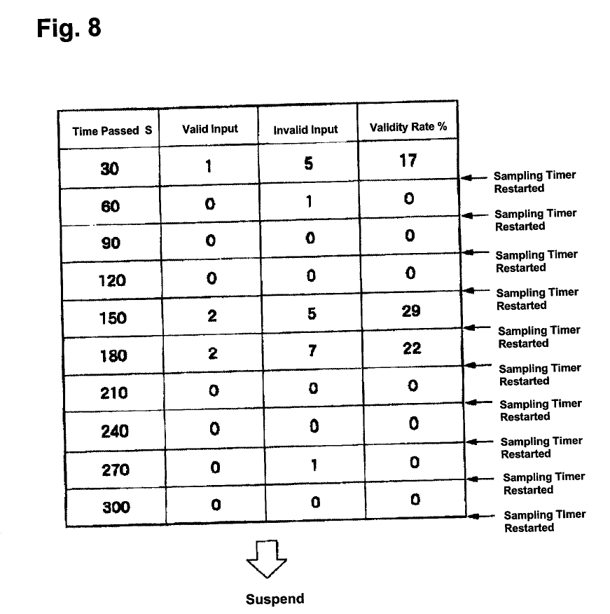

FIG. 8 shows a drawing to describe the power control method in accordance with a second embodiment of the present invention. In this embodiment, for example, the same settings as those of the first embodiment described above are made.

FIG. 8 also shows elapsed times at 30 seconds intervals, and the number of valid inputs, the number of invalid inputs, and the validity rate (the number of valid key inputs/the number of all inputs) in each of these passages of time.

In this example, inputs are made in 30 seconds after the power supply is turned on, in which the number of valid inputs is 1, the number of invalid inputs is 5, and the validity rate is 17%. In this case, since the validity rate does not exceed 80%, the suspend timer continues its measuring operation, and the sampling timer is restarted.

During the sampling period in the next 30 seconds (until 60 seconds passes), the number of valid inputs is 0, the number of invalid inputs is 1, and the validity rate is 0%. Accordingly, the suspend timer continues its measuring operation, and the sampling timer is restarted.

During the sampling period in the next 30 seconds (until 90 seconds passes), the number of valid inputs is 0, the number of invalid inputs is 0, and the validity rate is 0%. Accordingly, the suspend timer continues its measuring operation, and the sampling timer is restarted.

Also, during the sampling period in the next 30 seconds (until 120 seconds passes), the number of valid inputs is 0, the number of invalid inputs is 0, and the validity rate is 0%. Accordingly, the suspend timer continues its measuring operation, and the sampling timer is restarted.

During the sampling period in the next 30 seconds (until 150 seconds passes), the number of valid inputs is 2, the number of invalid inputs is 5, and the validity rate is 29%. Accordingly, the suspend timer continues its measuring operation, and the sampling timer is restarted.

During the sampling period in the next 30 seconds (until 180 seconds passes), the number of valid inputs is 2, the number of invalid inputs is 7, and the validity rate is 22%. Accordingly, the suspend timer continues its measuring operation, and the sampling timer is restarted.

During the sampling period in the next 30 seconds (until 210 seconds passes), the number of valid inputs is 0, the number of invalid inputs is 0, and the validity rate is 0%. Accordingly, the suspend timer continues its measuring operation, and the sampling timer is restarted.

Also, during the sampling period in the next 30 seconds (until 240 seconds passes), the number of valid inputs is 0, the number of invalid inputs is 0, and the validity rate is 0%. Accordingly, the suspend timer continues its measuring operation, and the sampling timer is restarted.

During the sampling period in the next 30 seconds (until 270 seconds passes), the number of valid inputs is 0, the number of invalid inputs is 1, and the validity rate is 0%. Accordingly, the suspend timer continues its measuring operation, and the sampling timer is restarted.

During the sampling period in the next 30 seconds (until 300 seconds passes), the number of valid inputs is 0, the number of invalid inputs is 0, and the validity rate is 0%. Accordingly, the sampling timer is restarted. Here, the elapsed time reaches the suspend time of 300 seconds. In this case, as described above with reference to FIG. 6, the suspend process is conducted, and the power saving mode is started.

In this example, unnatural inputs are made. This example assumes an incident when the user forgets to turn off the power on the mobile electronic apparatus and places the same in their clothes or a bag, and the clothes often contacts the touch panel or the like to cause frequent inputs. In this manner, even when inputs are made when the user forgets to turn off the power supply, the power saving mode can be started after a specified time has passed if the validity rate is low.

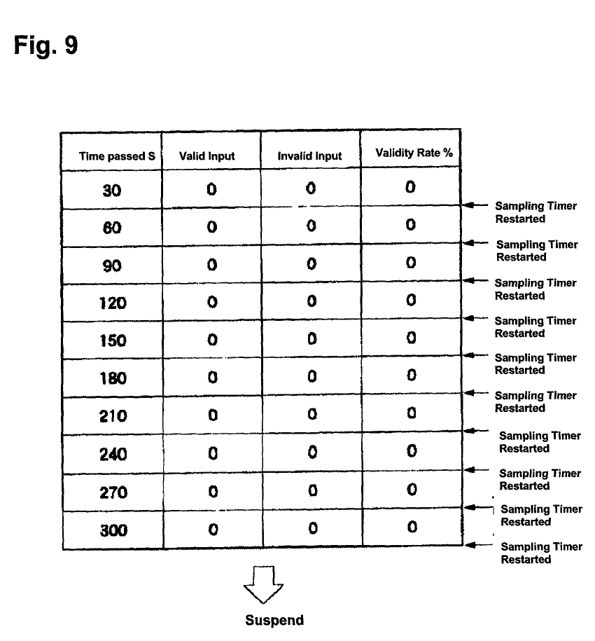

FIG. 9 shows a drawing to describe the power control method in accordance with a third embodiment of the present invention. In this embodiment, the same settings as those of the first embodiment and the second embodiment described above are made.

FIG. 9 also shows elapsed times at 30 seconds intervals, and the number of valid inputs, the number of invalid inputs, and the validity rate (the number of valid key inputs/the number of all inputs) in each of these passages of time.

In this example, there are no inputs made during 300 seconds after the power supply is turned on, and therefore the number of valid inputs is 0, the number of invalid inputs is 1, and the validity rate is 0%. As the elapsed time reaches the suspend time of 300 seconds, the suspend process is conducted, and the power saving mode is started.

This example assumes an incident when the power supply on the mobile electronic apparatus placed in the clothes or the bag is inadvertently turned on, or when the electronic apparatus is left without any inputs being made for a specified time, and therefore provides a function that is the same as the normal power saving mode. In this manner, with the settings same as those of the first and second embodiments, the normal power saving mode can also be conducted.

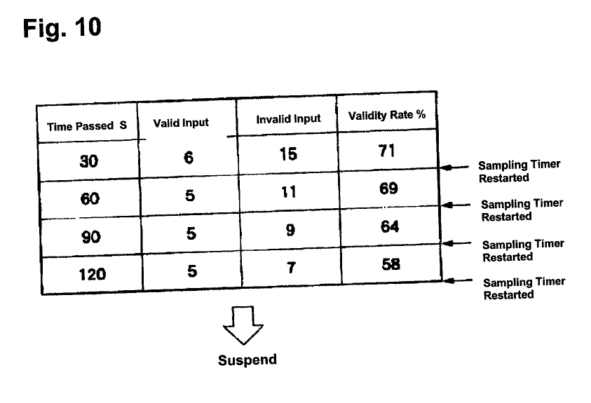

FIG. 10 shows a drawing to describe the power control method in accordance with a fourth embodiment of the present invention.

In this embodiment, for example, the following settings are made.

Suspend time: 5 minutes

Sampling time: 30 seconds

Valid/Invalid comparison reference: The suspend timer is restarted when a validity rate (the number of valid key inputs/the number of all inputs) exceeds 80%. Also, when an invalidity rate (the number of invalid key inputs/the number of all inputs) exceeds 50% four times in succession, the power saving mode is started.

Here, this example assumes an incident when a password input process is conducted. Accordingly, in this example, the term “valid input” indicates a case when a correct password is inputted, and the term “invalid input” indicates a case when an incorrect password is inputted.

In the present embodiment, the counter (see FIG. 5) calculates invalid rate counter values to obtain the number of inputs that exceed an invalidity rate of 50%.

FIG. 10 shows elapsed times at 30 seconds intervals, and the number of valid inputs, the number of invalid inputs, and the invalidity rate (the number of invalid key inputs the number of all inputs) in each of these passages of time.

In this example, for 30 seconds after the power supply is turned on, the number of valid inputs is 6, the number of invalid inputs is 15, and the validity rate is 71%. In this case, since the validity rate does not exceed 80%, the suspend timer continues its measuring operation, and the sampling timer is restarted. However, since the invalidity rate exceeds 50%, the counter increases the invalidity rate counter by one.

During the sampling period in the next 30 seconds (until 60 seconds passes), the number of valid inputs is 5, the number of invalid inputs is 11, and the validity rate is 69%. In this case also, since the validity rate does not exceed 80%, the suspend timer continues its measuring operation, and the sampling timer is restarted. Also, since the invalidity rate exceeds 50%, the counter increases the invalidity rate counter by one.

During the sampling period in the next 30 seconds (until 90 seconds passes), the number of valid inputs is 5, the number of invalid inputs is 9, and the validity rate is 64%. In this case also, since the validity rate does not exceed 80%, the suspend timer continues its measuring operation, and the sampling timer is restarted. Also, since the invalidity rate exceeds 50%, the counter increases the invalidity rate counter by one.

During the sampling period in the next 30 seconds (until 120 seconds passes), the number of valid inputs is 5, the number of invalid inputs is 7, and the validity rate is 58%. In this case also, since the validity rate does not exceed 80%, the suspend timer continues its measuring operation, and the sampling timer is restarted. Also, since the invalidity rate exceeds 50%, the counter increases the invalidity rate counter by one. At this moment, although the suspend time has not yet reached 300 seconds, the invalid rate counter value becomes to be four, and the invalidity rate has exceeded 50% four times in succession. Accordingly, the power saving mode is started as preset.

In this manner, when someone else inputs incorrect passwords multiple times, the power saving mode can be started even before the suspend time is reached, to thereby extend the time until the password is released.

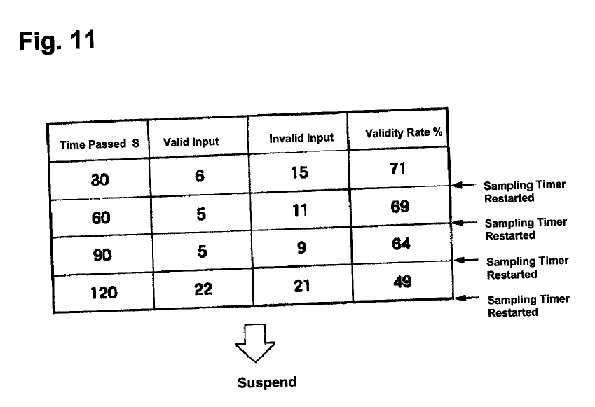

FIG. 11 shows a drawing to describe the power control method in accordance with a fifth embodiment of the present invention.

In this embodiment, for example, the following settings are made.

Suspend time: 5 minutes

Sampling time: 30 seconds

Valid/Invalid comparison reference: The suspend timer is restarted when a validity rate (the number of valid key inputs/the number of all inputs) exceeds 80%. Also, when the number of invalid inputs within each sampling period exceeds 20 times, the power saving mode is started.

FIG. 11 shows elapsed times at 30 seconds intervals, and the number of valid inputs, the number of invalid inputs, and the invalidity rate (the number of invalid key inputs/the number of all inputs) in each of these passages of time.

In this example, for 30 seconds after the power supply is turned on, the number of valid inputs is 6, the number of invalid inputs is 15, and the validity rate is 71%. In this case, since the validity rate does not exceed 80%, the suspend timer continues its measuring operation, and the sampling timer is restarted. Also, since the number of invalid inputs within this sampling period does not exceed 20 times, the power saving mode is not started.

During the sampling period in the next 30 seconds (until 60 seconds passes), the number of valid inputs is 5, the number of invalid inputs is 11, and the validity rate is 69%. In this case also, since the validity rate does not exceed 80%, the suspend timer continues its measuring operation, and the sampling timer is restarted. Also, since the number of invalid inputs within this sampling period does not exceed 20 times, the power saving mode is not started.

During the sampling period in the next 30 seconds (until 90 seconds passes), the number of valid inputs is 5, the number of invalid inputs is 9, and the validity rate is 64%. In this case also, since the validity rate does not exceed 80%, the suspend timer continues its measuring operation, and the sampling timer is restarted. Also, since the number of invalid inputs within this sampling period does not exceed 20 times, the power saving mode is not started.

Further, during the sampling period in the next 30 seconds (until 120 seconds passes), the number of valid inputs is 22, the number of invalid inputs is 21, and the validity rate is 49%. In this case, since the number of invalid inputs within this sampling period exceeds 20 times, the power saving mode as set is started.

This example assumes an incident when a child may wantonly depress the touch panel. In this manner, even if a child wantonly makes invalid key inputs many times but the invalidity rate is relatively low, the power saving mode can be started even before the suspend time is reached.

It is clear from the description above that, in accordance with the present invention, a power saving mode can be more effectively started by conducting valid/invalid judgments with respect to key inputs, and comparing frequencies thereof or the like.

While this invention has been described in conjunction with specific embodiments thereof, it is evident that many alternatives, modifications, and variations will be apparent to those skilled in the art. Accordingly, preferred embodiments of the invention as set forth herein are intended to be illustrative, not limiting. Various changes may be made without departing from the spirit and scope of the invention.

What is claimed is:

1. An electronic apparatus, comprising:
a display device including an input device;
a timer that calculates a specified suspend time and sampling time;
a counter that counts a specified number of key inputs;
a power control device that controls a power supply;
a judging device that judges at each of the sampling time whether a key input inputted through the input device is valid or invalid; and
a control device that controls the input device, the timer, the counter, the power control device and the judging device,
wherein, based on judgment results by the judging device, the control device counts valid inputs with the counter when the key inputs inputted through the input device are judged to be valid, counts invalid inputs with the counter when the key inputs inputted through the input device are judged to be invalid, and compares the number of the valid key inputs with the number of the invalid key inputs to make a determination, wherein the control device further resets and restarts the timer that measures the specified suspend time when a ratio of the number of the valid inputs to the number of the invalid inputs is less than a specified threshold value, and controls the power control device to start a power saving mode when a measured result of the timer reaches the suspend time.

2. The electronic apparatus according to claim 1, a valid input region and an invalid input region being provided in the display device, and the control device controlling the display device and judging that a key input in the valid input region is valid and a key input in the invalid input region is invalid.

3. The electronic apparatus according to claim 1, wherein, when a validity rate defined by the number of valid inputs divided by the number of all inputs obtained from the counted value of the counter exceeds a specified threshold value, the timer that measures the specified suspend time is reset and restarted.

4. The electronic apparatus according to claim 1, wherein, when a measured result of the timer reaches the suspend time while a validity rate defined by the number of valid inputs divided by the number of all inputs obtained from the counted value of the counter does not exceed a specified threshold value, the power control device is controlled to start a power saving mode.

5. The electronic apparatus according to claim 1, wherein, when an invalidity rate defined by the number of invalid inputs divided by the number of all inputs obtained from the counted value of the counter exceeds a specified threshold value, the power control device is controlled to start a power saving mode even when a measured result of the timer has not reached the suspend time.

6. The electronic apparatus according to claim 1, wherein, when the number of invalid inputs exceeds a specified threshold value, the power control device is controlled to start a power saving mode even when a measured result of the timer has not reached the suspend time.

7. A power control method, comprising:
displaying information on a display device;
receiving key inputs from an input device provided on the display device;
calculating a specified suspend time and sampling time by using a timer;
counting a specified number of key inputs by using a counter;
judging at each of the sampling time if a key input inputted through the input device is valid or invalid; and
controlling a power supply, p1 wherein, based on results of the judging as to validity/invalidity, valid inputs are counted when the key inputs inputted through the input device are judged to be valid, invalid inputs are counted when the key inputs inputted through the input device are judged to be not valid, and a number of the valid key inputs is compared with a number of the invalid key inputs to make a determination, wherein the timer that measures the specified suspend time is reset and restarted when a ratio of the number of the valid inputs to the number of the invalid inputs is less than a specified threshold value, and the power supply is controlled to start a power saving mode when a measured result of the timer reaches the suspend time.

8. The power control method according to claim 7, a valid input region and an invalid input region being provided in the display device, a key input in the valid input region being judged to be valid and a key input in the invalid input region being judged to be invalid.

9. The power control method according to claim 7, wherein, when a validity rate defined by the number of valid inputs divided by the number of all inputs obtained from the counted value of the counter exceeds a specified threshold value, the timer that measures the specified suspend time is reset and restarted.

10. The power control method according to claim 7, wherein, when a measured result of the timer reaches the suspend time while a validity rate defined by the number of valid inputs divided by the number of all inputs obtained from the counted value of the counter does not exceed a specified threshold value, the power control device is controlled to start a power saving mode.

11. The power control method according to claim 7, wherein, when an invalidity rate defined by the number of invalid inputs divided by the number of all inputs obtained from the counted value of the counter exceeds a specified threshold value, the power control device is controlled to start a power saving mode even when a measured result of the timer has not reached the suspend time.

12. The power control method according to claim 7, wherein, when the number of invalid inputs exceeds a specified threshold value, the power control device is controlled to start a power saving mode even when a measured result of the timer has not reached the suspend time.
